(19) United States
(12) Patent Application Publication
(10) Pub. No.: US 2018/0304307 A1
(43) Pub. Date: Oct. 25, 2018

(54) Water-Borne Coating Compositions

(71) Applicant: HEWLETT-PACKARD DEVELOPMENT COMPANY, L.P., HOUSTON, TX (US)

(72) Inventors: Ya-Ting YEH, TAIPEI CITY (TW); KUAN-TING WU, TAIPEI CITY (TW); YICHIEH CHANG, TAIPEI CITY (TW)

(21) Appl. No.: 15/565,481

(22) PCT Filed: May 22, 2015
(86) PCT No.: PCT/US2015/032100

§ 371 Date: Oct. 10, 2017

(51) Int. Cl. B05D 7/00; B05D 3/00; B05D 5/08; B05D 7/14

(52) U.S. Cl. CPC B05D 7/54; B05D 7/14; B05D 5/083; B05D 3/002

(57) ABSTRACT

Provided in one examole hod of manufacturing. The method includes disposing over at least a portion of a substrate a first layer, the substrate comprising a metal material and the first layer comprising a water-borne primer. The method includes disposing over at least a portion of the first layer a second layer, the second layer comprising a water-borne basecoat material. The method includes disposing over at least a portion of the second layer a third layer, the third layer comprising a water-bome topcoat material.

### BACKGROUND

The housing/casing of an electronic device may comprise multiple components. The components may include covers. In the case of a portable electronic device having a display, these covers may include a top cover CA cover“), the display itself ('B cover”), the keyboard cover (“C cover”), and the bottom cover (“D cover”). Depending on the application, the cover may comprise a variety of suitable materials.

### BRIEF DESCRIPTION OF THE DRAWINGS

The drawings are provided to illustrate various examples of the subject matter described herein in, this disclosure (hereinafter “herein” for short) related to water-borne coating compositions and are not intended to limit the scope of the subject matter. The drawings are not necessarily to scale.

FIGS. 1A-1B show two example schematics of two articles comprising a substrate coated by multiple layers formed by water-borne compositions.

FIG. 2 provides a flowchart showing, in one example, the processes involved in making an article described herein,

FIG. 3 provides a flowchart showing, in one example, the processes involved in making an article described herein.

FIG. 4 shows, in one example, a schematic of an electronic device comprising a housing comprising an article described herein.

### DETAILED DESCRIPTION

Often a metal-containing component (e.g., a part of the housing) of a device (e.g., electronic device) is coated with at least one layer of paint. The paint-containing layer(s) may be applied for a variety of reasons, including to provide protection against corrosion (e.g., chemical corrosion, physical corrosion, etc.) or to achieve a certain physical appearance. However, pre-existing paints employed in such an application generally contain organic solvents. Organic solvent-bone (hereinafter “solvent-borne” for short) paints may cause health or environmental safety concerns due at least in part to the emission of relatively high levels of volatile organic compounds in solvent-borne paints.

In view of the aforementioned challenges related to solvent-borne paints used in coatngs, the Inventors have recognized and appreciated the advantages of a water-borne composition as coating maternal., Following below are more detailed descriptions of venous examples related to Water-borne coating compositions. The various examples described herein may be implemented in any of numerous ways.

Provided in one aspect of the examples is a method of manufacturing, comprising: disposing over at least a portion of a substrate a first layer, the substrate comprising a metal material and the first layer comprising a water-borne primer: disposing over at least a portion of the first layer a second layer, the second layer comprising a water-borne basecoat material; and disposing over at least a portion of the second layer a third layer, the third layer comprising a water-borne topcoat material.

Provided in another aspect of the examples is a method of manufacturing, comprising: cleaning a surface of a substrate comprising a metal material: disposing over at least a portion of the surface a first layer, the first layer comprising a water-borne primer; disposing over at least a portion of the first layer a second layer, the second layer comprising a water-borne basecoat material; and disposing over at least a portion of the second layer a third layer, the third layer comprising a water-borne topcoat material comprising a fluoropolymer.

Provided in another aspect o the examples is an electronic device, comprising: an electrical circuit; a housing exterior to the electrical circuit, the housing comprising an article comprising: a substrate comprising a metal material; a first layer disposed over at least a portion of the substrate, the first layer formed from a water-horn primer; a second layer disposed over at least a portion ofthe first layer, the second layer formed from a water-borne basecoat material: and a third layer disposed over at least a portion of the second layer, the third layer formed from a water-borne topcoat material.

### Water-Borne Coating Compositions

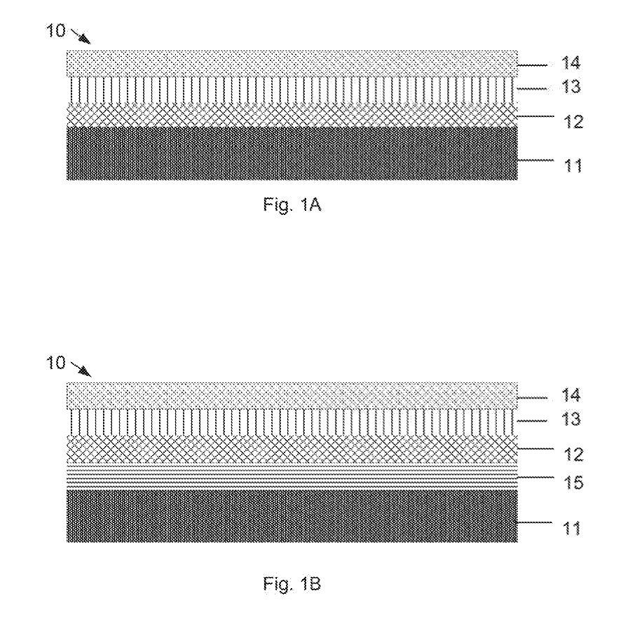

FIG. 1A provides a schematic of one, example of an article described herein. In this example, the article 10 comprises a substrate 11, a first layer 11, a first layer 12, a second layer 13, and a third layer 14. FIG. 1B provides a schematic of another example of an article described herein. In this example, the article 10 comprises a substrate 11, a first layer 12, a second layer 13, a third layer 14, and a fourth layer 15. It is noted that the terms “first,” “second,' third,” etc. herein are merely used to connote that the objects they respectively describe are different entities and are not meant to describe any chronological order, unless explicitly specified.

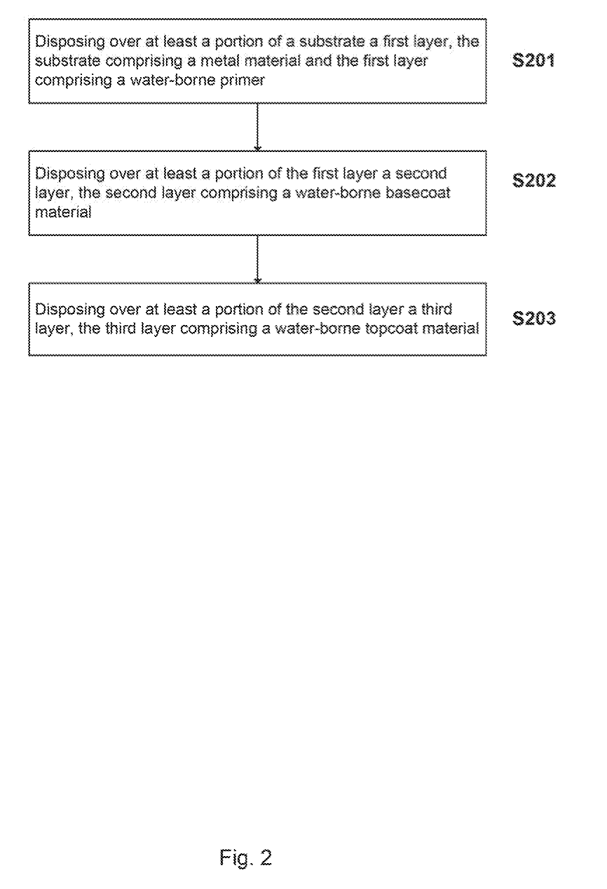

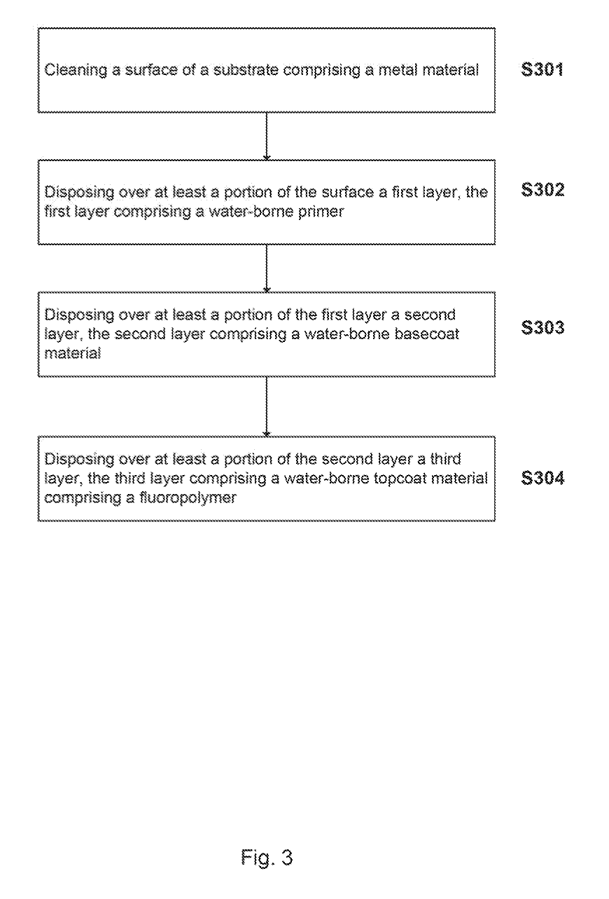

The articles described herein may be manufactured by any suitable method involving any suitable number of processes. FIGS. 2 and 3 illustrate the processes involved in two example methods of manufacturing the articles described herein.

FIG. 2 illustrates the processes involved in one example of a method of manufacturing the articles described herein. The method may comprise disposing over at least a portion of a substrate a first layer, the substrate comprising a metal material and the first layer comprising a water-borne primer (S201). The substrate material may be any of those described herein. The water-borne primer material may be any of those described herein. The method may further comprise disposing over at least a portion of the first layer a second layer, the second layer comprising a water-borne basecoat material (S202). The water-borne basecoat material may be any of those described herein, Subsequently, the method may further comprise disposing over at least a portion of the second layer a third layer, the third layer comprising a water-borne topcoat material (S203). The water-borne topcoat material may be any of those described herein. It is noted that in each of the disposing processes described, herein, a new layer may be disposed over at least a portion of (a surface ot) the underlying layer, the ‘at least a portion’ referring to both scenarios of a portion of the surface and the entire surface.

The substrate 11 may comprise a metal material. A metal material may refer to any material containing a metal, such as a pure metal, an alloy, or intermetallic compound. The metal may be any suitable metal. A metal material may comprise aluminum, magnesium, lithium, titanium, an alloy of any of the foregoing or combinations thereof. Other materials are also possible.

The first layer 12 may comprise a water-borneprimer (composition). The term “water-borne” when used to describe a composition herein may refer to an aqueous composition in which the solvent is water and the solute is dissolved (and dissociated) or suspended in the water solvent. It is noted that in some instances the solute may be partially dissolved in the water solvent, due at least in part to solubility—and thus partially suspended. The water may be any suitable water, including purified water, deionized water, etc., depending on the application. The compositions described herein for the different layers disposed over the substrate may be, for example, paint compositions. The paint compositions may be commercially available paint compositions or may be custom-made paint compositions.

The primer may comprise an inorganic materiai, an organic material, or both. The primer material may comprise carbon black, titanium dioxide, clay, mica, talc, barium sulfate, calcium carbonate, a pigment, a metal-containing powder, aluminum oxide, graphene, graphite, or combinations thereof. The metal-containing powder may be organic powder or inorganic powder. Other materials are also possible. The primer material may be present in the water-borne primer composition at any suitable amount. In one example, the primer material is present at greater than or equal to about 50 wt % of the water-borne rimer composition—e.g., greater than or equal to about 60 wt %, about 70 wt %, about 80 wt %, about 90 wt %, about 95 wt % or higher. in another example, the primer material is present at lower than about 50 wt % of the water-borne prin composition—lower than or equal to about 40 wt %, about 30 wt %, about 20 wt %, or lower. Other amount values are also possible.

The second layer 13 may comprise a water-borne basecoat (composition). The basecoat may comprise an inorganic material, an organic material, or both. The basecoat material may comprise barium sulfate, talc, a dye, a color pigment, or combinations thereof. The basecoat material may be present in the water-borne basecoat composition at any suitable amount. in one example, the basecoat material is present at greater than or equal to about 50 wt % of the water-borne basecoat composition greater than or equal to about 60 wt %, about 70 wt %, about 80 wt %, about 90 wt %, about 95 wt %, or higher. In another example, the basecoat is present at lower than about 50 wt % of the water-borne basecoat composition—e.g., lower than or equal to about 40 wt %, about 30 wt %, about 20 wt %, or lower. Other amount values are also possible.

The third layer 14 may cornpnse a water-borne topcoat (compostion). The topcoat may comprise an organic material, For example, the topcoat material may comprise a tluoropolymer polymer. In one example, the topcoat material comprises a hydrophobic polymer. in one example, the topcoat material comprises a hydrophobic fluoropolymer polymer. In one example, the topcoat material comprises a fluorinated olefin-based polymer, in one example, the topcoat material comprises a flubropolymer selected from the group consisting o luoroacrylate, a fiuorosillcone acrylate, a fluorourethane, a perfluoropolyether, a perfiuoropolyoxetane, a fluorotelomer, a polytetrafluoroethylene (“PTEF”), a polyvinylidenefluouride (“PVDF”), a fluorosiloxane, and a fluoro ultra-violet (“UV”) polymer. In one example, the fluorotelomer is a short chain polymer. For example, the short chain polymer may have six or fewer carbons. In one example, the topcoat rateril is a hydrophobic polymer that has seven or more carbons,

The topcoat material may be present in tl e water-borne topcoat composition at any suitable amount. In one example, the topcoat material is present at greater than or equal to about 50 wt % of the water-borne topcoat composition—e.g., greater than or equal to about 60 wt %, about 70 wt %, about 80 wt %, about 90 wt %, about 95 wt %, or higher. In another example, the topcoat is present at lower than about 50 wt % of the water-borne topcoat composition—e.g., lower than or equal to about 40 wt %, about 30 wt %, about 20 wt %, or lower. Other amount values are also possible.

In one example, the topcoat material of the third layer 14 may comprise additional materials to the fluoropolymer described above. For example, the topcoat material may comprise a fluoropolymer polymer and at least one of a dispersed thermoplastic and a dispersed thermoset. In one example, the dispersed thermoplastic and/or thermoset renders the topcoat layer into a soft-touch layer, providing relative soft sensation to a user upon touching the layer. The dispersed thermoplastic and/or thermoset may be dispersed in a matrix comprising the fluoropolymer.

The thermoplastic and the thermoset may be any suitable polymer, depending on the application. The thermoplastic may comprise at least one of thermoplastic urethane elastomer, a styrenic block copolymer, a copolyether ester elastomer, and a polyester amide elastomer. Other thermoplastic. materials are also possible. The thermoset may comprise at least one of an alkyl acrylate copolymer, a butadiene, a chlorinated polyethylene, an isobutylene-isoprene copolymer, an ethylene propylene, an epichlorhydrin, another fluoropolymer different from the fluoropolymer, a nitrile, an isoprene, a ehloroprene, a polysulphide, a polyurethane, a silicone, a styrene butadiene, and a tetrafluoroethylene propylene. In one example, the ethylene a propylene is ethylene propylene rubber (“EPM”), in one example, the polyurethane is a hydrogenated nitrile rubber (“HNBR”), Other thermoset materials are also possible.

The nethod may further comprise additional processes. For example, the method may further comprise disposing a layer (erg., a “fourth layer” in the example as illustrated in FIG. 1B) over at least a portion of the substrate before the first layer is disposed. In this example, the first layer is then disposed over at least a portion of the fourth layer. The fourth layer may comprise a powder. The powder may comprise an organic material, an inorganic material, or both, In one example, the powder comprises an organic polymer. The polymer may be any suitable polymer, depending on the application. For example, the polymer may be at least one of an acrylic, a polurethane, and an epoxy. Other polymers may also be possible.

Each of the disposing processes described herein may involve any suitable number of disposition techniques, depending on the application and/or the materials involved. For example, the disposing may involve painting (as applied with a brush), spraying, dipping, etc. Depending on the application and the materials involved, the parameters associated a particular disposing process (e.g., temperature, pressure, duration of drying, etc.) need not be limited to any particular values and may vary.

The method may further comprise cleaning the surface of a substrate before any layer is disposed over the surface. Fig, 3 illustrates the processes involving such a cleaning process in one example of a method of manufacturing the articles described herein. As shown in FIG. 3, the method may comprise cleaning a surface of a substrate comprising a metal material (S301). The cleaning process may involve application of a specific pressure olvent, temperature, etc., depending on the materials involved, to remove unwanted fluid (e.g., oil) and/or solid (e.g., sand) from the surface. Cleaning may involve, for example, degreasing and/or rinsing the surface with an agent to remove unwanted articles. The agent may be a fluid, such as a liquid and a gas. The liquid may be, for example, water or an organic solvent. The gas may be, for example, an inert gas.

The method as illustrated in FIG. 3 may further comprise disposing over at least a portion of the surface a first layer, the first layer comprising a water-borne primer (S302). The water-borne primer may be any of those described herein. The method may further comprise disposing over at least a portion of the first layer a second layer, the second layer comprising a water-borne basecoat material (S303). The water-borne basecoat material may be any of those described herein. The method may further comprise disposing over at least a portion of the second layer a third layer, the third layer comprising a water-borne topcoat material comprising a fiuoropolymer (S304). The water-borne topcoat material may be any of those described herein.

It is noted that each of the different layers described herein may be disposed to the extent that the layer has a certain thickness. However, the thickness need not be of any value and may vary depending on the application.. In one example, the thickness is in the micrometer scale. For example, the thickness may be less than or equal to about 500 μm—e.g., less than or equal to about 400 μm, about 300 μm, about 200 μm, about 100 μm, about 50 μm, about 25 μm, about 20 μm, about 15 μm, about 10 μm, or smaller. In one example, the thickness is between about 10 μm and about 30 μm—e.g., between about 15 μm and about 25 μm, etc. Other thickness values, including those larger than about 500 μm, are also possible. The thickness values of the different layers may be the same as, or may be different from, one another. In one example, at least some of the layers have the same thickness value. In another example, all of the layers have different thickness values from one another.

The method of manufacturing described herein may further comprise process(es) to dry the water-borne compositions in the different layers (e.g., first layer, second layer, third layer, etc.) of the articles des.cribed to remove the water solvent The drying may involve any suitable technique that may be employed to remove the water solvent from a composition. For example, the drying may involve application of heat andior exposure of the composition to air (e.g., ambient air). Each layer may be dried before the next water-borne composition is disposed thereover to form a subsequent layer. Although in one example all of the layers are first dried before the subsequent layer is applied, in another example at least one layer is not dried before the application of the subsequent layer. It is noted that at least because of the drying process(es), in at least one example the final composition of each layer in the article may be different from the composition as applied—e.g., the solid content may increase at least as a result of the reduction of the water solvent due to drying.

In contrast to pre-existing coating/paint compositions that commonly employ organic solvent, the water-borne coating compositions described herein may have a lower emission level of volatile organic compound (“VOC”). For example, the water-borne compositions described herein may have at least about 50% reduction in VOC emission in comparison to an organic solvent counterpart—e.g., at least about 60%, about 70%, about 80%, about 90%, about 95%, or higher in reduction. Depending on the materials involved, the VOC emission of the water-borne primer layer may be less than or equal to about 250 g/L—e.g., less than or equal to about 200 g/L, about 150 g/L, about 100 g/L, about 50 g/L, or less. Depending on the materials involved, the VOC emission of the water-borne basecoat layer may be less than or equal to about 250 g/L—e.g., less than or equal to about 200 g/L, about 150 g/L, about 100 g/L, about 50 g/L, or less. Depending on the materials involved, the VOC emission of the water-borne topcoat layer may be less than or equal to about 150 g/L—e.g., less than or equal to about 100 g/L, about 50 g/L, or less. Other values are also possible.

### Applications

The articles described herein may have several beneficial properties, particularly over the pre-existing techniques of making coatings using organic solvent-borne paint/coating compositions. For example, the processes (and thus the resultant products manufactured by same) described herein may lower adverse environmental impact by reducing VOC emission level. Also, a process of disposing a water-borne composition may also be more environmentally friendly and safe (with respect to health) thantha thaf of disposing an organic solvent-borne composition.

Due at least in part to the numerous aforedescribed desirable properties, the articles and the methods of manufacturing same described herein may be employed in various applications. For example, the article may be an integral part of a structural component. The component may be a part of the housing of an electronic device. A housing of a device may refer to any structural component that encloses the, interior of the device, in one example, the article described herein is a part of the housing of an electronic device, For example, the article may be any part of the housing, including back cover, front cover, side cover, and the like, of the device.

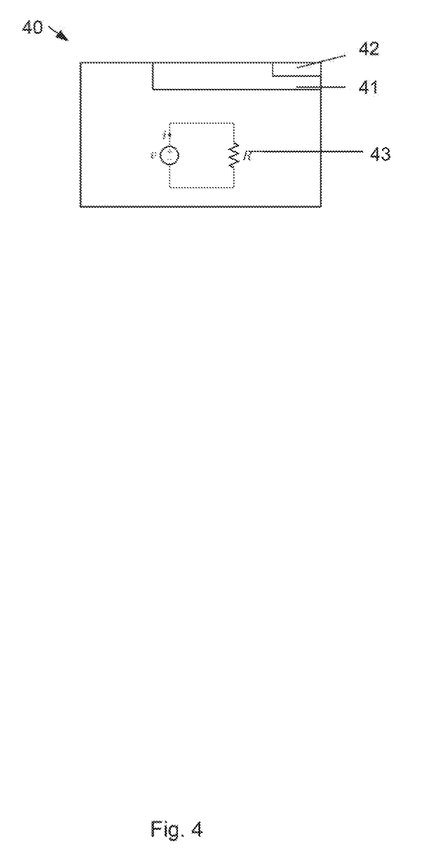

FIG. 4 shows, in one example, a schematic of an electronic device 40 comprising a housing 41 comprising an article 42, including any of the articles described herein. The housing (or a part thereof) 41 is external to the electrical circuit 43 in the interior of the device 40. The electrical circuit 43 may be any type of electrical circuit having any suitable configuration and component. It is noted that while FIG. 4 shows that the article is in a portion of the top cover, the article may constitute the entire cover on one side, or multiple sides, as a part of the housing of the device.

An electronic device herein may refer to any device comprising at least one electrical circuit. Thus, in one example, the housing that comprises the article described herein may be external to the electrical circuit. The electronic device may be a consumer electronic device. An electronic device may refer to portable/mobile electronic device, An electronic device here may refer to a computer, a memory storage, a display, a signal transmitting device, and the like. A computer may refer to a desktop, a laptop, a tablet, a phablet, a tablone, and the like. A storage unit may refer to the hardware of a hard drive, a server, a processor, and the like. A display may refer to a monitor, a liquid crystal display (“LCD”), a television, and the like. A signal transmitting device may refer to a device transmitting any type of signal, including light, sound, heat, and the like. In one example, the electronic device is a mobile phone.

### Additional Notes

It should be appreciated that ail combinations of the foregoing concepts (provided such concepts are not mutually inconsistent) are contemplated as being part of the inventive subject matter disclosed herein. In particular, all combinations of claimed subject matter appealing at the end of this disclosure are contemplated as being part of the inventive subject natter disclosed herein. It should also be appreciated that terminology explicitly employed herein that also may appear in any disclosure incorporated by reference should be accorded a meaning most consistent with the particular concepts disclosed herein.

The indefinite articles “a” and “an,” as us in this disclosure, including the claims, unless clearly indicated to the contrary, should be understood to mean “at least one.” Any ranges cited herein are inclusive.

The terms “substantially” and “about” used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Concentrations, ar ounts, and other numerical data may be expressed or presented herein in a range format. Such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 weight % (wt %) to 5 wt %” should be interpreted to include not only the explicitly recited values of 1 wt % to 5 wt %, but also include individual values and sub-ranges within the indicated range. Thus, included in this numerical range are individual values, such as 2, 3.5, and 4, and sub-ranges, such asfrom 1-3, from 2-4, and from 3-5, etc. This same principle applies to ranges reciting only one numerical value. Furthermore, such an interpretation should apply regardless of the breadth of the range or the characteristics being described,

The phrase “and or,” as used herein in this disclosure, including the claims, should be understood to mean “either or both” of the elements so conjoined, i.e., elements that are conjunctively present in some cases and disjunctively present in other cases, Multiple elements listed with “and/or': should be construed in the same fashion, i.e., one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc

As used in this disclosure, including the claims, “or” should be understood to have the same meaning as “andior” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. in general, the term “or” as used herein shall only be interpreted as indicating exclusive alternatives (i.e. “one or the other but not both”) when preceded by terms of exclusivity, such as “either,” “one of,” “only one of,” or “exactly one of,” “Consisting essentially of,” when used in the claims, shall have its ordinary meaning as used in the field of patent law.

As used in this disclosure, including the claims, the phrase “at least one,” in reference a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one. A, and at least one, optionally including more than one, B (and optionally including other elements): etc.

In this disclosure,including the clair s, all transitional phrases such as “comprising,” “including.” “carryine”having, “containing,” “involving,” “holding,” “composed of,” and the like are to be understood to be open-ended, i.e., to mean including but not limited to, Only the transitional phrases “consisting of” and “consisting essentially of” shall be closed or semi-closed transitional phrases, respectively, as set forth in the United States Patent Office Manual of Patent Examining Procedures, § 2111.03.

What is claimed:

1. A method of manufacturing, comprising:
disposing over at least a portion of a substrate a first layer, the substrate comprising a metal material and the first layer comprising a water-borne primer;
disposing over at least a portion of the first layer a second layer, the second layer comprising a water-borne basecoat material; and
disposing over at least a portion of the second layer a third layer, the third layer comprising a water-borne topcoat material.

2. The method of claim 1, wherein the metal material comprises aluminum, magnesium, lithium, titanium, an alloy of any of the foregoing, or combinations thereof.

3. The method of claim 1, wherein the primer material comprises carbon black, titanium dioxide, clay, mica, talc, barium sulfate, calcium carbonate, a pigment, a metal-containing powder, aluminum oxide, graphene, graphite, or combinations thereof.

4. The method of claim 1, wherein the basecoat material comprises barium sulfate, talc, a dye, a color pigment, or combinations thereof.

5. The method of claim 1, wherein the topcoat material comprises a hydrophobic fluoropolymer polymer.

6. The method of claim 1, wherein the topcoat material comprises a fluorinated olefin-based polymer.

7. The method of claim 1, wherein the topcoat material comprises,a fluoropo ymer selected from the group consisting of a fluoroacrylate a fluorosilicone acrylate, a fluorourethane, a perfluoropolyether, a perfluoropolyoxetane, a fluorotelomer, a polytetrafiuoroethylene, a polyvinylidenefluouride, a fluorosiloxane, and a fluoro UV polymer.

8. The method of claim 1, wherein the topcoat material comprises a fluoropolymer polymer and at least one of a dispersed thermoplastic and a dispersed thermoset.

9. The method of claim , further comprising disposing over at least portion of the substrate a fourth layer comprising a powder comprising a polymer before disposing the first layer such that the first layer is disposer. over at least a portion of the fourth layer.

10. The method of claim 1. further comprising drying at least one of the first layer, the second layer, and the third layer.

11. A method of manufacturing, comprising:
cleaning a surface of a substrate comprising a metal material;
disposing over at least a portion of the surface a first layer, the first layer comprising a water-borne primer;
disposing over at least a portion of the layer a second layer, the second layer comprising a water-borne basecoat material: and
disposing over at least a portion of the second layer a third layer, the third layer comprising a water-borne topcoat material comprising a fluoropolymer.

12. The method of claim 11, wherein
the topcoat material further comprises at least one of a dispersed thermoplastic and a dispersed thermoset elastomer;
the dispersed thermoplastic comprises at least one of a thermoplastic urethane elastomer, a styrenic block copolymer, a copolyether ester elastomer, and a polyester amide elastomer; and
the dispersed thermoset comprises t least one of an alkyl acrylate copolymer, a butadiene, a chlorinated polyethylene, an isobutylene-isoprene, copolymer, an ethylene propylene, an epichlorhydrin, another fluoropolymer different from the fluoropolymer, nitrile, an isoprene, a chloro, rene, a polysulphide, a polyurethane, a silicone, a styrene butadiene and a tetrafluoroethylene propylene.

13. The method of claim 11, further comprising disposing over at least a portion of the substrate a fourth layer comprising powder comprising a polymer before disposing the first layer, such that the first layer is disposed over at least a portion of the fourth layer.

14. An electronic device, comprising:
an electrical circuit;
a housing exterior to the electrical circuit, the housing comprising an article comprising:
a substrate comprising a metal material;
a first layer disposed over at least a ortion cf the substrate, the first layer formed from a water-borne primer;
a second layer disposed over at least, a portion: of the flat ayer, the second layer formed from a water-borne basecoat material; and
a third layer disposed over at least a portion of the second layer, the third layer formed from a water-borne topcoat material.

15. The electronic device of claim 14 wherein at least one of the first layer, the second layer, and the third layer has a thickness of less than or equal to about 25 μm
